(19) United States
(12) Patent Application Publication
(10) Pub. No.: US 2007/0033161 A1
(43) Pub. Date: Feb. 8, 2007

(54) Apparatus and method for automatic refinement of business processes

(75) Inventors: Jae-bum Park, Seoul (KR); Jin hee Kim, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/498,083

(22) Filed: Aug. 3, 2006

(30) Foreign Application Priority Data
Aug. 4, 2005 (KR) 10-2005-0071434

(51) Int. Cl. G06F 17/30

(52) U.S. Cl. 707/2

(57) ABSTRACT

An apparatus and a method for automatically refining a business process. The method for automatically refining a business process according to an exemplary embodiment of the present invention includes the steps of setting key performance indicators (KPIs) and generating a matrix using KPI-related items, performing regression analysis using the items prepared for the matrix and recording the results of the regression analysis, and reflecting the results of the regression analysis by recording items of the regression analysis in a repository.

### CROSS-REFERENCE TO RELATED APPLICATION

This application claims priority from Korean Patent Application No. 10-2005-0071434 filed on Aug. 4, 2005, in the Korean Intellectual Property Office, the disclosure of which is incorporated herein in its entirety by reference.

### BACKGROUND OF THE INVENTION

1. Field of the Invention

The present invention relates to a method and an apparatus for automatic growth of business processes and, more particularly, to a method and an apparatus for automatic growth of business processes whereby a matrix is generated by using key performance indicators, regression analyses are carried out using the matrix elements, and the results of regression analyses are reflected in business processes.

2. Description of the Related Art

Various statistic indicators are used for quick decision-making and countermeasures in the course of business administration, and a series of operations to produce these statistic indicators are managed as processes. The cause and effect relations between the indicators can be analyzed, and models can be established, verified and predicted via the regression analyses. In order to do this, a variety of indicators are needed. The statistic indicators can be utilized via association of an established database with regression analyses. To enhance the utilization of the indicators, use of real-time data is required. The analysis of the real-time data may greatly increase the productivity of business administrations since it influences generation and management of current processes and indicators.

The related arts are described in Japanese Unexamined Patent Publication No. 2003-216804 and in Korean Unexamined Patent Publication No. 2001-0109387.

In Japanese Patent Publication No. 2003-216804, a prediction system is disclosed that gathers information on enterprises, evaluates each individual enterprise and stores evaluation data of the enterprises in a database. In response to an input from an operation terminal, the system selects data suitable for establishing a model, and converts elements suitable for creating the database, conducts regression analyses, and establishes models for each enterprise. The system then applies a prediction result of each model to the concerned individual enterprise after a predetermined period of time has elapsed, to thereby measure the operation accuracy of the model.

In Korean Patent Publication No. 2001-0109387, a management support system is described that comprises a client that calculates and provides economy and business indices based on various kinds of data produced by the business management, an operating server that comparatively analyzes indicator levels for each business element by referencing databases based on the economy and business indicator indices provided by the client on-line or off-line, diagnoses the analysis results, proposes an alternative resource according to the diagnosis results, and finally provides data associated with executable elements in the alternative resource, and a data server containing a variety of databases.

However, the related arts are directed to a method of inputting data, conducting diverse logical analyses according to the input data, and applying the input data in order to predict results, which are manually output at a user's request. Accordingly, the user has to intervene in business processes, and they cannot be automatically advanced by accumulating input data.

### SUMMARY OF THE INVENTION

The present invention addresses the above-described problems of the related arts. An object of the present invention is to provide a method and an apparatus for automatic growth of business processes, in which reliable data resulting from real-time mapping analysis between a database and a regression analyzer can be utilized and current indicators and processes can automatically be managed.

According to another object of the present invention, there is provided a method and an apparatus for automatic growth of business processes, not only for storage and management of data, whereby prediction information automatically generated from accumulated data influences business processes and key factors in real-time.

The present invention will not be limited to the technical objects described above. Other objects not described herein will be more definitely understood by those in the art from the following detailed description.

According to an aspect of the present invention, an apparatus for automatically refining a business process includes a storage unit that stores data, processes, and results of regression analyses; a data input unit that inputs key performance indicators (KPIs) established by a user and data associated with the input KPIs extracted from the storage unit; a regression analysis unit that performs regression analyses using data input by the data input unit; and a feedback unit that reflects the results of regression analyses by storing the results of regression analyses.

According to another aspect of the present invention, a method for automatically refining a business process includes the steps of generating a data repository and a process repository by storing data and processes associated with key performance indicators (KPIs) established by a user, inputting KPIs and data associated with the input KPIs extracted from the data repository, performing regression analyses using the input data, and reflecting the results of regression analyses by storing them in the regression analysis result repository.

### BRIEF DESCRIPTION OF THE DRAWINGS

The above aspects and other features of the present invention will become more apparent by describing in detail exemplary embodiments thereof with reference to the attached drawings in which:

FIG. 1 is a block diagram illustrating the composition of an apparatus for automatic growth of a business process according to an exemplary embodiment of the present invention;

FIG. 2 is a diagram illustrating the construction of a storage unit of the method for refining an automatic business process according to an exemplary embodiment of the present invention;

FIG. 3 is a block diagram illustrating the construction of a data input unit of the automatic-business-process-refining apparatus according to an exemplary embodiment of the present invention;

FIG. 4 is a block diagram illustrating the constitution of a regression analysis unit of the automatic-business-process-refining apparatus according to an exemplary embodiment of the present invention;

FIG. 5 is a block diagram illustrating the construction of a feedback unit of the automatic-business-process-refining apparatus according to an exemplary embodiment of the present invention;

FIG. 6 is a flowchart schematically illustrating a method for automatically refining a business process according to an exemplary embodiment of the present invention;

FIG. 7 is a flow chart illustrating a data input operation of the method for automatically refining a business process according to an exemplary embodiment of the present invention;

FIG. 8 is a flow chart illustrating a regression analysis operation in the method for automatically refining a business process according to an exemplary embodiment of the present invention; and

FIG. 9 is a flow chart illustrating a reflection operation of the regression analysis results in the method for automatically refining a business process according to an exemplary embodiment of the present invention.

### DETAILED DESCRIPTION OF EXEMPLARY EMBODIMENTS

Aspects and features of the present invention and methods of accomplishing the same may by understood more readily by reference to the following detailed description of the exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

Exemplary embodiments of the present invention will be described in more detail with reference to the accompanying drawings.

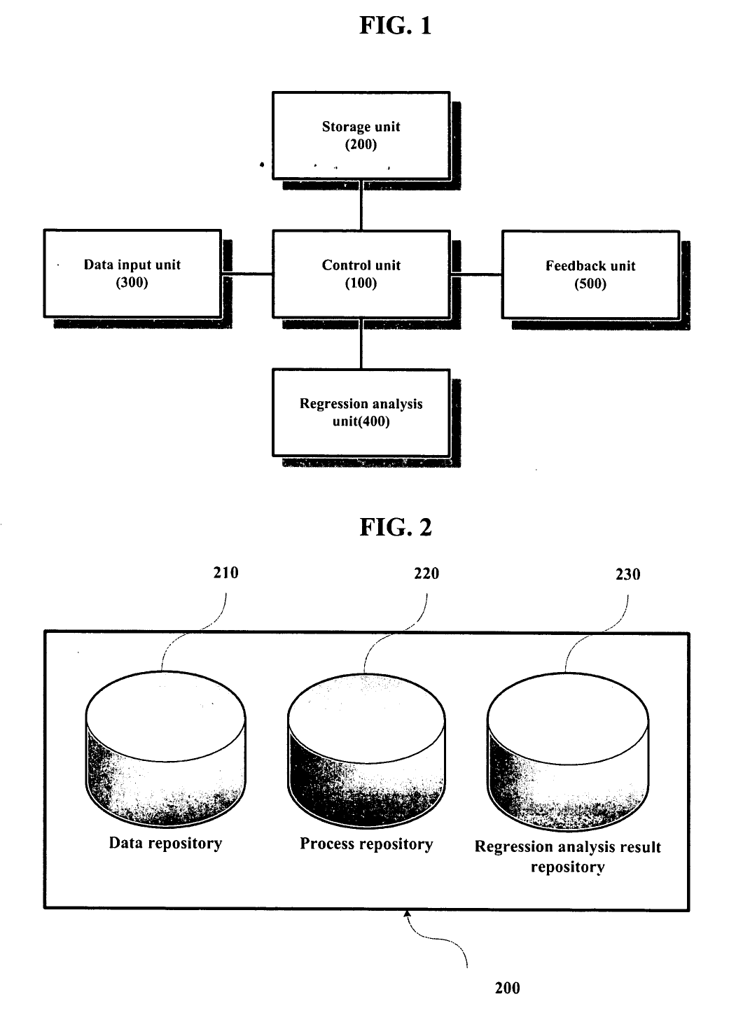

FIG. 1 is a block diagram illustrating the composition of an apparatus for automatically refining a business process according to an exemplary embodiment of the present invention. The illustrated apparatus includes a control unit 100, a storage unit 200, a data input unit 300, a regression analysis unit 400 and a feedback unit 500.

The storage unit 200 stores data, processes, and results of regression analyses. FIG. 2 illustrates the composition of the storage unit 200 of the apparatus for automatically refining a business process according to an exemplary embodiment of the present invention.

The illustrated storage unit includes a data repository 210 that stores data, a process repository 220 that stores processes, and a regression analysis result repository 230 that stores the results of regression analyses.

The data input unit 300 inputs key performance indicators (KPIs) established by a user, and inputs data associated with the input KPIs, which is extracted from the storage unit 200.

Here, a “KPI” is not an indicator of a past accomplishment of an enterprise, such as income or profit, but evaluation criteria covering several key indicators influencing future performance. The KPI is advantageous because it expresses the goals to be managed and accomplished for each person and each sector according to the performance indicators of an enterprise. Further business activities to be performed for achieving the goals of an enterprise become clear and concrete, and the efforts of employees to achieve the business goals can be effectively performed.

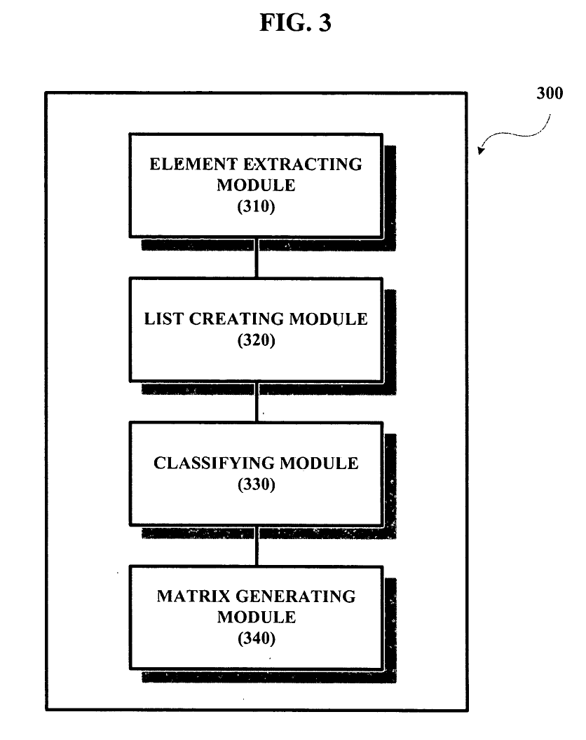

Modules that compose the data input unit 300 are depicted in FIG. 3, which is a block diagram illustrating the construction of the data input unit of the apparatus for automatically refining a business process according to an exemplary embodiment of the present invention.

The illustrated data input unit 300 comprises an element extracting module 310 that extracts data from the storage unit 200 or processes associated with KPIs established by a user, a list-creating module 320 that analyzes the sources of data or processes extracted by the element extracting module 310 and creates a list of the data or processes, a classifying module 330 that classifies the list elements into data and processes, and a matrix generating module 340 that generates a matrix using the list elements classified by the classifying module 330. When the elements classified by the classifying module 330 are processes, the matrix generating module 340 extracts data mapped to the processes by using information on the process resources stored in the process repository 220. Likewise, when the elements classified by the classifying module 330 are data, the matrix generating module 340 extracts the most recent data, and generates a matrix using combinable data of the extracted data as elements.

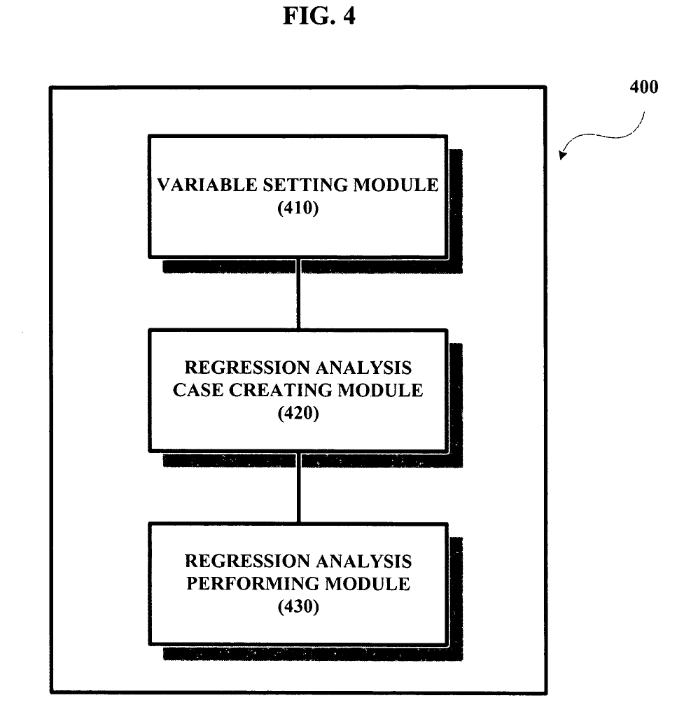

The regression analysis unit 400 performs regression analyses by using data input by the data input unit 300, which is described in the following with reference to FIG. 4.

FIG. 4 illustrates the construction of the regression analysis unit 400 of the apparatus for automatically refining a business process according to an exemplary embodiment of the present invention.

The regression analysis unit 400 includes a variable setting module 410 that sets data forming the matrix as independent variables, and KPIs to be obtained based on the set independent variables as dependent variables, a regression analysis case creating module 420 that creates a list of regression analysis cases at the user's demand by using independent variables and dependent variables set by the variable setting module 410, and a regression analysis performing module 430 that performs regression analyses based on the case list created by the regression analysis case creating module 420 by using the variables set by the variable setting module 410, and stores the results (data) of the regression analyses in the regression analysis result repository 230.

In particular, the variable setting module 410 determines whether the number of set dependent variables exceeds a predetermined number. When the number of set dependent variables exceeds the predetermined number, some dependent variables are subtracted so that the number of set variable numbers is less than the predetermined number. When the number of set dependent variables does not exceed the predetermined number, the dependent variables are retained.

The feedback unit 500 reflects the results of the regression analyses by storing the regression analysis results created by the regression analysis unit 400 in the storage unit 200.

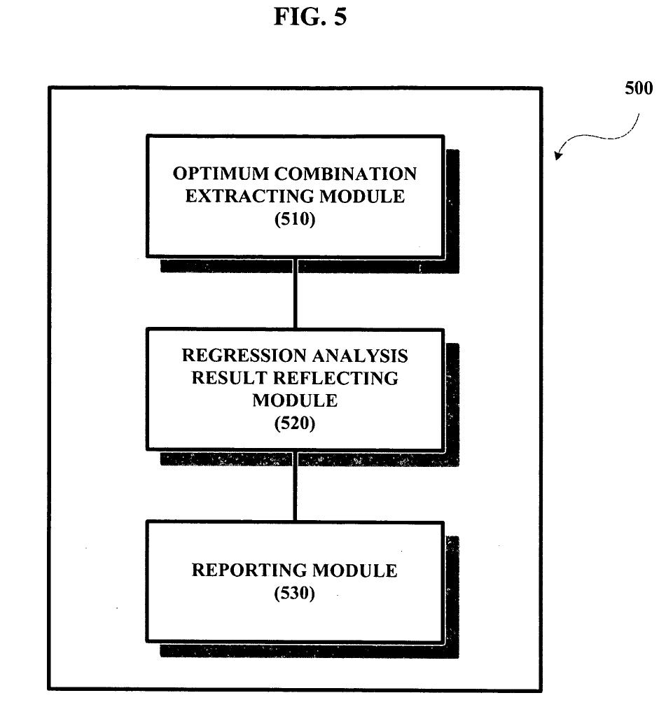

FIG. 5 is a block diagram illustrating the construction of the feedback unit 500 of the method for automatically refining a business process according to an exemplary embodiment of the present invention. The feedback unit 500 is described in detail with reference to FIG. 5.

The feedback unit 500 includes an optimum combination extracting module 510 that extracts the optimum combinations of dependent variables using data from the regression analysis result repository 230, a regression analysis result reflecting module 520 that records the optimum combinations extracted by the optimum combination extracting module 510 in the data repository 210, the process repository 220 and the regression analysis result repository 230 to thereby reflect the results of the regression analyses, and a reporting module 530 that reports the regression analysis results reflected by the regression analysis reflecting module 520 to the user. In particular, the regression analysis result reflecting module 520 determines whether it is necessary to adjust the combinations of dependent variables extracted by the optimum combination extracting module 510, and records any altered combination in the repositories when there is an adjusted variable, or records the original combinations in the repositories when there is no need to adjust variables. A report can be given to the user via short message service (SMS), e-mail or another wired or wireless communication method.

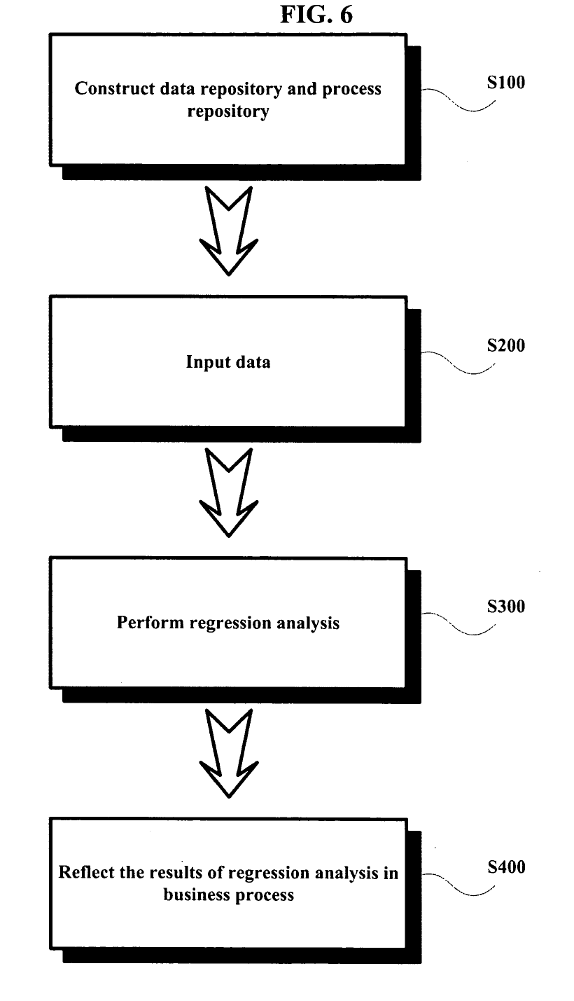

FIG. 6 is a flow chart schematically illustrating a method for automatically refining a business processes according to an exemplary embodiment of the present invention.

First, a data repository 210 and a process repository 220 are generated to respectively store data and processes associated with KPIs set by a user in operation S100. Second, the KPIs are input into the regression analysis unit 400 and data associated with the input KPIs are extracted from the data repository 210 and input into the regression analysis unit 400 in operation S200. Next, regression analyses are performed using the input data in operation S300. Finally, the results produced by the regression analyses are stored in the regression analysis repository 230, whereby the regression analysis results are reflected in operation S400.

Each operation is described in detail in the following.

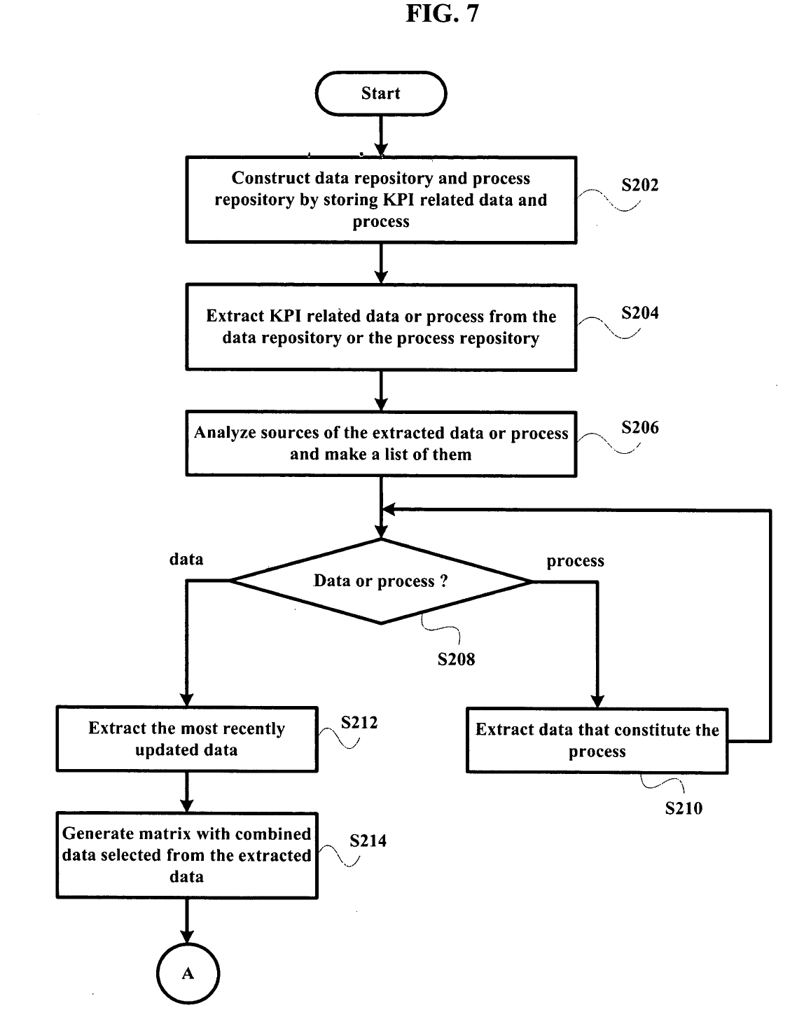

FIG. 7 is a flow chart illustrating a data input operation in the method for automatically refining a business process according to an exemplary embodiment of the present invention.

In operation S202, KPI's are input and data or processes associated with the input KPIs are input. KPI associated data or processes are extracted from the data repository 210 or the process repository 220 in operation S204, and sources of the extracted data or processes are analyzed and a list for the data or processes is created in operation S206.

The elements of the list are classified into data and processes in operation S208. When processes are classified, data composing the processes is extracted from the process repository 220 using information on process resources stored in the process repository 220 in operation S210. When data is classified, the most recent data is extracted from the data repository 210 in operation S212, and a matrix is formed with combined data as elements in operation S214.

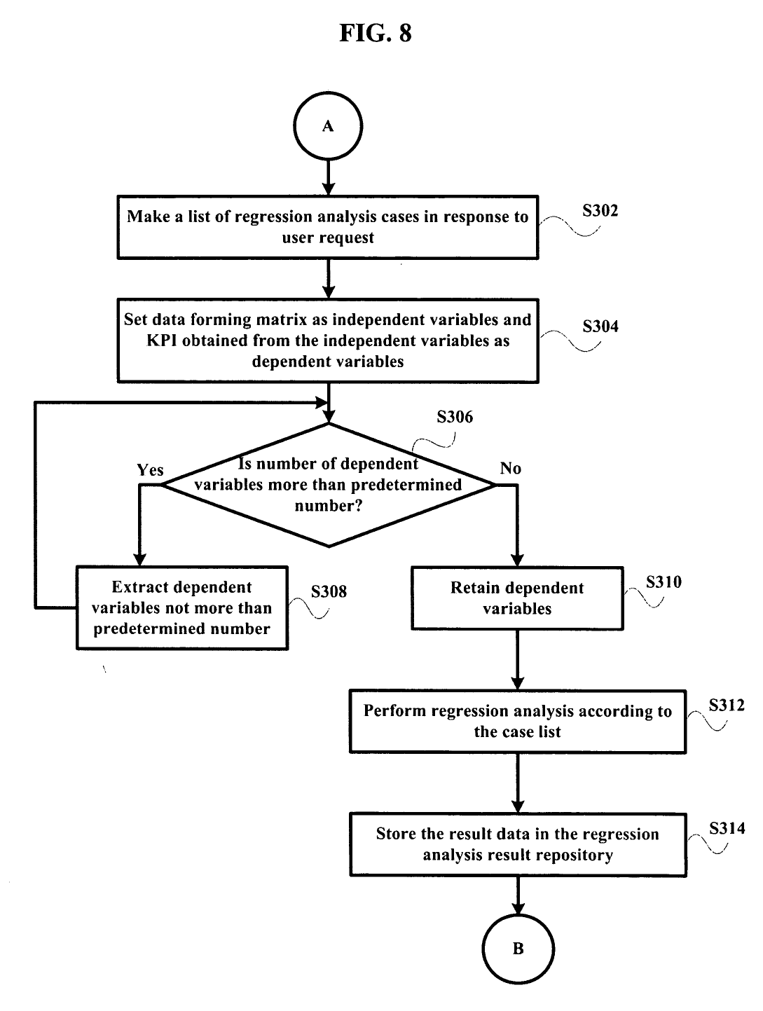

FIG. 8 is a flow chart illustrating a regression analysis operation of the method for automatically refining a business process according to an exemplary embodiment of the present invention.

First, a list of regression analysis cases is generated at a user's request in operation S302, and data forming the matrix is set as independent variables and KPIs obtained from the set independent variables are set as dependent variables in operation S304. Then, it is determined whether the number of set dependent variables exceeds a predetermined number in operation S306. If the number of set dependent variables exceeds the predetermined number, a number of dependent variables is extracted in operation S308 so as to be less than the predetermined number. If the number of dependent variables is less than the predetermined number, the dependent variables are retained in operation S310.

According to the generated case list, regression analyses are performed in operation S312, and the results (data) of the regression analyses are stored in the regression analysis result repository 230 in operation S314.

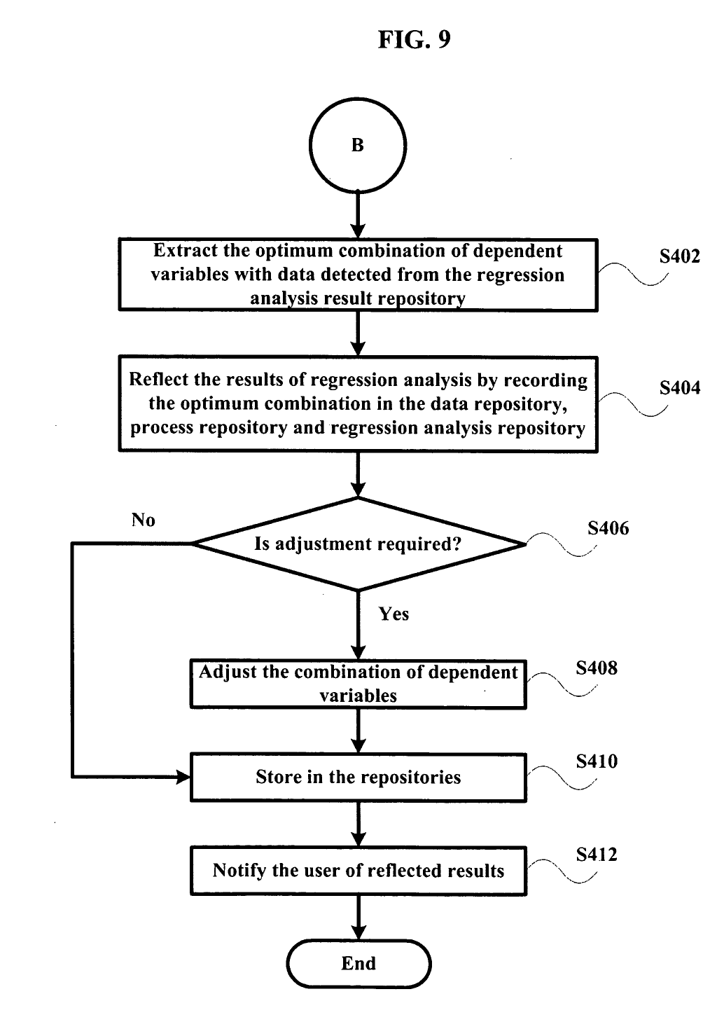

FIG. 9 is a flow chart illustrating an operation of reflecting the results of regression analyses in the method for automatically refining a business process according to an exemplary embodiment of the present invention.

Optimum combinations are extracted from combinations of dependent variables using data from the regression analysis result repository 230 in operation S402. The optimum combinations are recorded in the data repository 210, the process repository 220, and the regression analysis result repository 230, to thereby reflect the results of the regression analyses in operation S404. Then, it is determined whether the dependent variable combinations extracted by the optimum combination extracting module 510 need to be adjusted in operation S406. If it is necessary to adjust the variables, the variables are adjusted in operation S408 and the adjusted combinations are recorded in the repositories in operation S410. If it is not necessary to adjust variables, the original combinations are recorded in the repositories in operation S410. Finally, the result of the reflection is reported to the user in operation S412. This report is given by short message service (SMS), e-mail, or another wired or wireless communication method.

According to an exemplary embodiment of the present invention, a system consisting of business processes can be constructed where business indicators can be automatically recognized from KPIs, whereby the business processes can be automatically managed by monitoring the KPIs.

According to an exemplary embodiment of the present invention, there can be provided a framework and a variety of engines that can be used for business process-oriented management, and that are automated according to KPI-based business processes rather than data-based business processes.

According to an exemplary embodiment of the present invention, it is possible to respond appropriately to changes in the business environment through real-time data processing using processing engines and repositories, and to effectively improve business activities and processes by deducing optimum countermeasures through a matrix associated with regression analyzers.

The present invention shall not be limited to the effects described above. It should be understood that other effects of the present invention not described above will be defined by the appended claims.

It should also be understood that the scope and spirit of the present invention includes a computer-readable recording medium recording a program for executing the methods described in exemplary embodiments of the present invention on a computer.

Further, it should be understood by those of ordinary skill in the art that various replacements, modifications and changes in the form and details may be made therein without departing from the spirit and scope of the present invention as defined by the following claims. Therefore, it is to be appreciated that the above described embodiments are for purposes of illustration only and are not to be construed as limitations of the invention.

What is claimed is:

1. An apparatus for automatically refining a business process, the apparatus comprising:
a storage unit that stores data, a process, and a result of regression analyses;
a data input unit that inputs a key performance indicator (KPI) and data associated with the input KPI extracted from the storage unit;
a regression analysis unit that performs regression analyses using the KPI and data associated with the input KPI input by the data input unit; and
a feedback unit that reflects the result of the regression analyses by storing the result of the regression analyses in the storage unit.

2. The apparatus of claim 1, wherein the storage unit comprises a data repository that stores data, a process repository that stores a process and a regression analysis result repository that stores the result of the regression analyses.

3. The apparatus of claim 1, wherein the data input unit comprises:
an element extracting module that extracts from the storage unit data or a process associated with KPI;
a list-creating module that analyzes a source of the data or the process extracted by the element extracting module and creates a list of the data or the process;
a classifying module that classifies elements of the list created by the list-creating module into data and processes; and
a matrix generating module that generates a matrix with combined data or process data from the data or process classified by the classifying module.

4. The apparatus of claim 3, wherein the matrix generating module extracts process data using information on the process resources stored in the process repository when the processes are classified, and extracts a most recent data in order to generate a matrix with combined data from the extracted data when the data is classified.

5. The apparatus of claim 3, wherein the regression analysis unit comprises:
a variable setting module that sets data or process data forming the matrix as independent variables, and KPIs obtained from the set independent variables as dependent variables;
a regression analysis case creating module that creates a list of regression analysis cases by using the independent variables and dependent variables set by the variable setting module; and
a regression analysis performing module that performs regression analyses with the list created by the regression analysis case creating module using the set independent and dependent variables, and records data results of the regression analyses in the regression analysis result repository.

6. The apparatus of claim 5, wherein the variable setting module determines whether the number of set dependent variables exceeds a predetermined number and subtracts from the set dependent variables when the number of set dependent variables exceeds the predetermined number so that the number of dependent variables is less than the predetermined number and obtains the values of the dependent variables when the number of set dependent variable is not more than the predetermined number.

7. The apparatus of claim 5, wherein the feedback unit comprises:
an optimum combination extracting module that extracts the optimum combinations of the dependent variables using the data results from the regression analysis result repository;
a regression analysis result reflecting module that reflects the data results of regression analyses by recording the optimum combinations extracted by the optimum combination extracting module in the data repository, the process repository, and the regression analysis result repository; and
a reporting module that reports the results of reflection by the regression analysis result reflecting module.

8. The apparatus of claim 7, wherein the regression analysis result reflecting module determines whether it is necessary to adjust the dependent variables in the variable combinations extracted by the optimum combination extracting module and, if necessary records adjusted combinations in the data repository, the process repository, and the regression analysis result repository and, if not necessary, records original combinations in the data repository, the process repository, and the regression analysis result repository.

9. The apparatus of claim 7, wherein the report of the result of reflection is given via one of a short message service (SMS), an e-mail and a wired or wireless communication method.

10. The apparatus of claim 1, wherein said KPI is established by a user.

11. The apparatus of claim 5, wherein the regression analysis case creating module creates a list of the regression analysis cases at a user's request.

12. The apparatus of claim 7, wherein said reporting module reports the results of reflection to the user.

13. A method for automatically refining a business process, the method comprising:
(a) generating a data repository and a process repository by storing data and a process associated with a key performance indicator (KPI);
(b) inputting a KPI and data associated with the input KPI extracted from the data repository;
(c) performing regression analyses using the input KPI and the data associated with the input KPI; and
(d) reflecting the result of the regression analyses by storing the result of the regression analysis in a regression analysis result repository.

14. The method of claim 13, wherein operation (b) further comprises:
(b-1) extracting data or a process associated with the KPI from the data repository or the process repository;
(b-2) analyzing sources of the extracted data or process, and creating a list of the sources of the extracted data or process;
(b-3) classifying the list elements into data and processes; and
(b-4) generating a matrix with combined data or processes extracted from the classified data as list elements.

15. The method of claim 14, wherein operation (b-4) further comprises, when a process is classified, extracting data composing the process using information on process resources stored in the process registry, and when data is classified, extracting most recent data in order to generate a matrix with combined data from the extracted most recent data.

16. The method of claim 14, wherein operation (c) further comprises:
creating a list of regression analysis cases;
setting data forming the matrix as independent variables and the KPI to be obtained from the set independent variables as dependent variables; and
performing regression analyses with the list of regression analysis cases using the set variables and recording the result of the regression analyses in the regression analysis result repository.

17. The method of claim 16, wherein the setting of the dependent variables is implemented by determining whether the number of set dependent variables is more than a predetermined number, and subtracting from the set dependent variables when the number of set dependent variables exceeds the predetermined number so that the number of dependent variables is less than the predetermined number, and obtaining the values of the set dependent variables when the number of set dependent variables is not more than the predetermined number.

18. The method of claim 16, wherein operation (d) comprises:
extracting the optimum combinations of dependent variables with the data result extracted from the regression analysis result repository;
reflecting the data result of the regression analyses by recording the optimum combinations in the data repository, the process repository and regression analysis result repository; and
reporting the reflection result.

19. The method of claim 18, wherein the reflecting of the regression analysis results is implemented by determining whether it is necessary to adjust the dependent variables in the dependent variable combinations extracted by the optimum combination extracting module, recording the adjusted combinations in the data repository, the process repository, and the regression analysis result repository if adjustment is necessary, and recording the original combinations in the data repository, the process repository, and the regression analysis result repository if adjustment is not necessary.

20. The method of claim 18, wherein the report of the reflection result is given via one of a short message service (SMS), an e-mail and a wired or wireless communication method.

21. The method of claim 13, wherein said KPI is established by a user.

22. The method of claim 20, wherein the report of the reflection result is given to a user.

23. A computer-readable recording medium that records a program for executing, on a computer, a method for automatically refining a business process, the method comprising:
(a) generating a data repository and a process repository by storing data and a process associated with a key performance indicator (KPI);
(b) inputting a KPI and data associated with the input KPI extracted from the data repository;
(c) performing regression analyses using the input KPI and the data associated with the input KPI; and
(d) reflecting the result of the regression analyses by storing the result of the regression analysis in a regression analysis result repository.

24. The computer-readable recording medium of claim 23, wherein operation (b) further comprises:
(b-1) extracting data or a process associated with the KPI from the data repository or the process repository;
(b-2) analyzing sources of the extracted data or process, and creating a list of the sources of the extracted data or process;
(b-3) classifying the list elements into data and processes; and
(b-4) generating a matrix with combined data or processes extracted from the classified data as list elements.

25. The computer-readable recording medium of claim 24, wherein operation (b-4) further comprises, when a process is classified, extracting data composing the process using information on process resources stored in the process registry, and when data is classified, extracting most recent data in order to generate a matrix with combined data from the extracted most recent data.

26. The computer-readable recording medium of claim 24, wherein operation (c) further comprises:
creating a list of regression analysis cases;
setting data forming the matrix as independent variables and the KPI to be obtained from the set independent variables as dependent variables; and
performing regression analyses with the list of regression analysis cases using the set variables and recording the result of the regression analyses in the regression analysis result repository.

27. The computer-readable recording medium of claim 26, wherein the setting of the dependent variables is implemented by determining whether the number of set dependent variables is more than a predetermined number, and subtracts from the set dependent variables when the number of set dependent variables exceeds the predetermined number so that the number of dependent variables is less than the predetermined number, and obtaining the values of the set dependent variables when the number of set dependent variables is not more than the predetermined number.

28. The computer-readable recording medium of claim 26, wherein operation (d) comprises:
extracting the optimum combinations of dependent variables with the data result extracted from the regression analysis result repository;
reflecting the data result of the regression analyses by recording the optimum combinations in the data repository, the process repository and regression analysis result repository; and
reporting the reflection result.

29. The computer-readable recording medium of claim 28, wherein the reflecting of the regression analysis results is implemented by determining whether to adjust the dependent variables in the dependent variable combinations extracted by the optimum combination extracting module, recording the adjusted combinations in the data repository, the process repository, and the regression analysis result repository if adjustment is necessary, and recording the original combinations in the data repository, the process repository, and the regression analysis result repository if adjustment is not necessary.

30. The computer-readable recording medium of claim 28, wherein the report of the reflection result is given via one of a short message service (SMS), an e-mail and a wired or wireless communication method.
